(19) United States
(12) Patent Application Publication
(10) Pub. No.: US 2012/0113621 A1
(43) Pub. Date: May 10, 2012

(54) BATWING BEAM BASED LED AND BACKLIGHT MODULE USING THE SAME

(75) Inventors: Hsiao-Wen LEE, Hsinchu City (TW); Chi Xiang TSENG, Kaohsiung City (TW)

(73) Assignee: TAIWAN SEMICONDUCTOR MANUFACTURING COMPANY, LTD., Hsinchu (TW)

(21) Appl. No.: 13/273,470

(22) Filed: Oct. 14, 2011

Related U.S. Application Data
(60) Provisional application No. 61/412,130, filed on Nov. 10, 2010.

(51) Int. Cl. G09F 13/04; B29C 31/00; F21V 5/04

(52) U.S. Cl. 362/97.1; 362/311.02; 156/245

(57) ABSTRACT

A batwing beam is produced from an LED package having a primary LED lens by molding the LED lens directly over an LED on a package substrate. The LED lens includes a cavity over a center of the LED. The cavity surface reflects light from the LED through total internal reflection (TIR) or through a reflectivity gel coating. The cavity may be a cone or a pyramid.

### CROSS-REFERENCE TO RELATED APPLICATIONS

The present application claims priority of U.S. Provisional Patent Application Ser. No. 61/412,130, filed on Nov. 10, 2010, which is incorporated herein by reference in its entirety.

### FIELD OF THE INVENTION

The present disclosure relates generally to a semiconductor device, and more particularly, to semiconductor lighting emitting diode (LED).

### BACKGROUND

A Light-Emitting Diode (LED), as used herein, is a semiconductor light source for generating a light at a specified wavelength or a range of wavelengths. LEDs are traditionally used for indicator lamps, and are increasingly used for displays. An LED emits light when a voltage is applied across a p-n junction formed by oppositely doping semiconductor compound layers. Different wavelengths of light can be generated using different materials by varying the bandgaps of the semiconductor layers and by fabricating an active layer within the p-n junction.

Traditionally, LEDs are made by growing a plurality of light-emitting structures on a growth substrate. The light-emitting structures along with the underlying growth substrate are separated into individual LED dies. At some point before or after the separation, electrodes or conductive pads are added to the each of the LED dies to allow the conduction of electricity across the structure. LED dies are then packaged by adding a package substrate, optional phosphor material, and optics such as lens and reflectors to become an optical emitter.

Optical emitter specifications typically identify application-specific radiation patterns outputted by the optical emitter. A commonly used beam pattern is the batwing beam pattern for illuminating a flat surface, in traffic signal applications, or for a backlighting unit in a display. The batwing beam pattern may be defined by having two roughly equal peaks in a candela distribution plot with a valley between the peaks at about 0 degrees. The batwing pattern may be defined by uniformity, a viewing angle, a minimum output measured at zero degrees, and peak angles. The uniformity defines the variability of the light output at different angles within a range of certain angles of interest, which may be the viewing angle. The viewing angle may be defined as the total angle at which 90% of the total luminous flux is captured. The minimum output at zero degrees is related to the uniformity. The peak angles determine the shape of the batwing and are related to the viewing angle.

Optical emitters are designed to meet these specifications. While existing designs of optical emitters have been able to meet batwing beam pattern requirements, they have not been entirely satisfactory in every aspect. Smaller and more cost effective designs that are easier to manufacture continue to be sought.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of an optical emitter in accordance with various embodiments of the present disclosure.

FIGS. 2A and 2B are rectangular candela distribution plots modeled using lenses in accordance with various embodiments of the present disclosure.

FIGS. 3A to 3C illustrate dimensions for various optical emitter lenses in accordance with various embodiments of the present disclosure.

FIGS. 4A to 4D are batwing cavity examples according to various embodiments of the present disclosure.

FIG. 5 is a flowchart illustrating a method of fabricating an optical emitter according to various aspects of the present disclosure.

FIGS. 6-11 illustrate cross-sectional views of an optical emitter at various stages of fabrication according to embodiments of the method of FIG. 5.

FIGS. 12A-12B illustrate cross-sectional views of an optical emitter at various stages of fabrication according to some embodiments of the present disclosure.

### SUMMARY

One aspect of the present disclosure involves an optical emitter including a Light-Emitting Diode (LED) die, a package substrate attached to one side of the LED die, electrical connections connecting the LED die and terminals on the package substrate, a molded lens bonded to the package substrate directly contacting the LED die that has an ellipsoidal cross section with a cavity centered over the LED die. The optical emitter outputs a batwing beam pattern through the molded lens.

Another aspect of the present disclosure involves a method of fabricating an optical emitter. The method includes attaching a Light-Emitting Diode (LED) die to a package substrate, electrically connecting the LED die and the package substrate, and molding a lens having a batwing cavity over the package substrate and the LED die. A molded phosphor component and/or reflectors may be formed on the LED die before the molded batwing lens.

The batwing cavity may have a shape of a cone or a pyramid. The cone or pyramid may have curved sides. The cavity surface reflects light from the LED through total internal reflection (TIR) or through a reflectivity gel coating. The batwing lens may have a circular base, an elliptical base, a rectangular base, or another polygonal base such as an octagonal base.

These and other features of the present disclosure are discussed below with reference to the associated drawings.

### DETAILED DESCRIPTION

It is understood that the following disclosure provides many different embodiments, or examples, for implementing different features of various embodiments. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. Of course, the description may specifically state whether the features are directly in contact with each other. In addition, the present disclosure may repeat reference numerals and/or letters in the various examples. This repetition is for the purpose of simplicity and clarity and does not in itself dictate a relationship between the various embodiments and/or configurations discussed.

An LED package, also referred to herein as an optical emitter, includes an LED die attached to a package substrate, an optional layer of phosphor material coating over the LED die, and some optical components such as reflector and lens. The LED die is electrically connected to circuitry on the package substrate in a number of ways. One connection method involves attaching the growth substrate portion of the die to the package substrate, and forming electrode pads that are connected to the p-type semiconductor layer and the n-type semiconductor layer in the light-emitting structure on the die, and then bond wiring from the electrode pads to contact pads on the package substrate. Another connection method involves inverting the LED die and using solder bumps to connect the electrode pads on the light-emitting structure directly to the package substrate. Yet another connection method involves using hybrid connectors. One semiconductor layer, for example the p-type layer, may be wired bonded to the package substrate while the other layer (n-type layer) may be soldered to the package substrate.

The LED package may include one or more phosphor materials that are usually applied directly onto the LED die. Methods of applying the one or more phosphor materials include spraying coating the phosphor materials in a concentrated viscous fluid medium, for example, liquid glue, onto the surface of the LED die through which the generated light must pass. As the viscous fluid sets or cures, the phosphor material becomes a part of the LED package. However, dosage and uniformity of a sprayed-on phosphor material is difficult to control.

Optical components such as a reflector and a lens are used to shape the radiation pattern, or beam pattern. Several optical components are often used to achieve a desired pattern, for example, a batwing beam pattern. A lens may be made of plastic, epoxy, or silicone and is attached to the package substrate by gluing its edge onto the package substrate. Usually, the lens is manufactured separately from the LED die and is available in specific sizes and shapes.

Batwing optical emitters use two lenses to achieve the batwing pattern. A first lens, or primary optic, is a transparent lens attached directly or formed directly on the LED die. The first lens is usually a semi-ellipsoid and functions primarily to extract as much light as possible from the LED die. A second lens, or secondary optic, is fitted and attached over the first lens and serves to shape the beam pattern. Thus, a variety of beam patterns may be generated by changing the second lens design without changing other portions of the LED package. Light thus generated by the LED die travels through a sapphire growth substrate if the LED is solder bonded to the package substrate, optional layers of phosphor material on the die, through a first lens, possibly a gap between the first and the second lens, and finally through the second lens for shaping the batwing pattern.

The batwing optical emitter using the combination of primary and secondary optics suffers from several issues with manufacturing, cost, and design. Because the second lens is made separately from the rest of the LED package, it is fitted over the first lens during assembly. Alignment of these optical components affects the resulting beam pattern and thus the tolerance for the alignment is very low. The low tolerance presents manufacturing issues and affects yield. Cost of the batwing optical emitter includes two lenses, which renders the batwing optical emitter more expensive than other optical emitters that generate other beam patterns. As the LED die becomes more efficient and its dimensions reduce, the separately made second lens and the alignment issue makes dimension reduction of the overall LED package difficult. The batwing second lens has a dimension of about 10 mm by 10 mm. While a smaller second lens can be made, a smaller lens magnifies misalignment issues and presents handling difficulties during final assembly. Furthermore, the gap between the first and second lens can reduce total light extraction by presenting yet more surfaces for reflection and refraction.

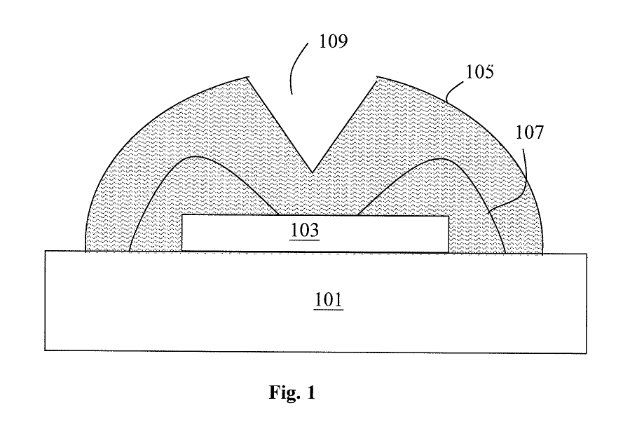

An optical emitter in accordance with the present disclosure involves only one lens molded directly on the LED die. The shape of the lens molded is such that a batwing pattern is generated directly through the lens. The cross-section shape is generally ellipsoidal having a batwing cavity centered over the LED die. The base of the lens may be ellipsoidal or polygonal. FIG. 1 shows a schematic of an optical emitter in accordance with various embodiments of the present disclosure. An LED die 103 is attached to a package substrate 101 and electrically connected to the package substrate by one or more connections 107. A lens 105 is formed over the LED die 103. The lens 105 includes a batwing cavity 109. While FIG. 1 shows an LED die 103 having wire bond type electrical connections 107, the various embodiments of the present disclosure are not limited to any particular type of LED die bonding. The concepts discussed herein work equally well with horizontal die bonding, flip chip solder type bonding, direct vertical LED chip bonding, or a hybrid of the different bonding types.

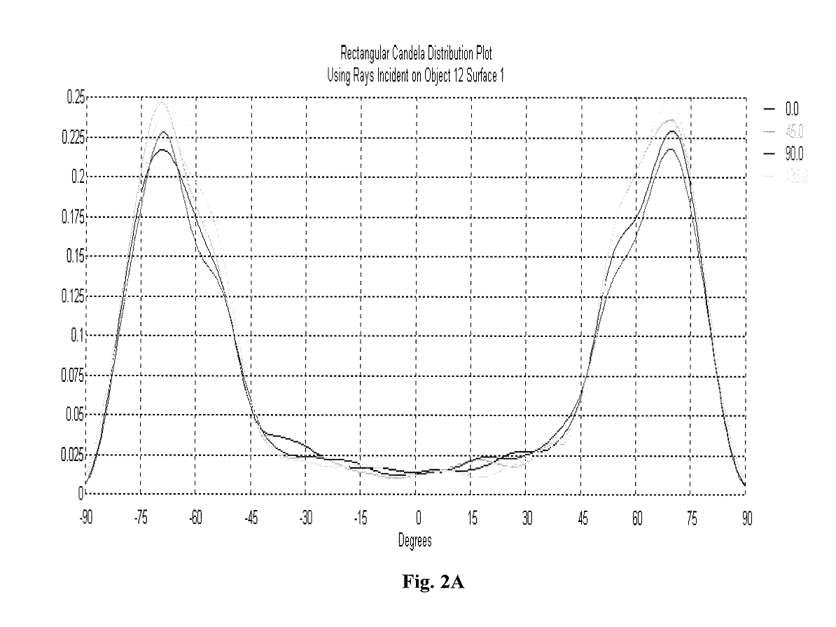

FIGS. 2A and 2B are rectangular candela distribution plots modeled using a lens in accordance with various embodiment of the present disclosure. The shapes of the curves in FIGS. 2A and 2B are typical batwing beam patterns. Modeled using data of a commercially available rectangular LED die and a molded lens having a general geometry of the lens 105 in FIG. 1, the plot of FIG. 2A shows light intensity on a surface at various angles, from −90 to 90 degrees, across the modeled LED package. The different lines present different lines of measurement across the LED package. For the rectangular LED die, the “0.0 line” represents calculated results from left to right along a centerline of the LED package. The “90.0 line” represents calculated results from top to bottom along another centerline of the LED package. The “45.0 line” and “135.0 line” represent calculated results from diagonal lines. Along all the lines, the lowest intensity was measured at zero degrees. Every line also shows a typical batwing pattern with two substantially equal peaks roughly equidistant from the valley between the peaks.

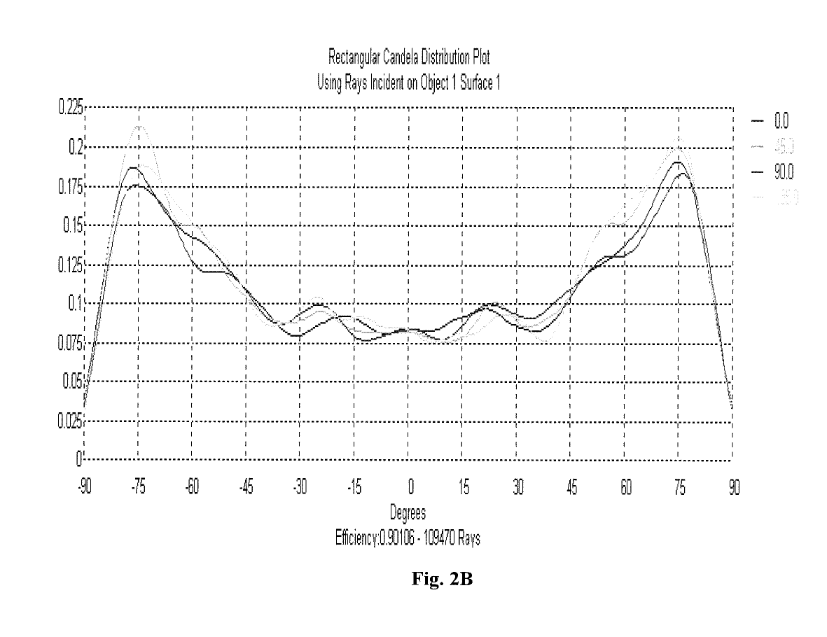

The plot of FIG. 2B is generated from a model of a commercially available rectangular LED die and a molded lens having a rectangular base, an ellipsoidal top, and a batwing cavity in the middle, similar to the lens illustrated in FIG. 3C. The plot shows that the results from the “0.0 line” and “90.0 line” are close to each other, while the results from the “45.0 line” and “135.0 line” are close to each other. The modeling result is consistent with the rectangular LED as the diagonal lines traverse more distance on the die.

The batwing pattern may be defined by a uniformity percentage, a viewing angle, a minimum output measured at zero degrees, and peak angles. These conditions are interrelated. By changing the lens geometry, an optical emitter can be made to satisfy a set of batwing conditions. FIGS. 3A to 3C illustrate various dimensions for an optical emitter lens in accordance with various embodiments of the present disclosure.

Referring to FIG. 3A, the lens 301 has an elliptical base plane where z=0. The elliptical base may be a circle or an ellipse, depending on the dimension of the LED die on which the lens 301 is formed. The lens 301 includes a batwing cavity 303. The surface of the batwing cavity 303 reflects and partially refracts light emitted from the LED die such that a batwing beam pattern is generated through the lens. As used in this disclosure herein, a batwing cavity is a cavity that can be configured in a lens to generate a batwing beam pattern and can have a variety of geometries according to various embodiments.

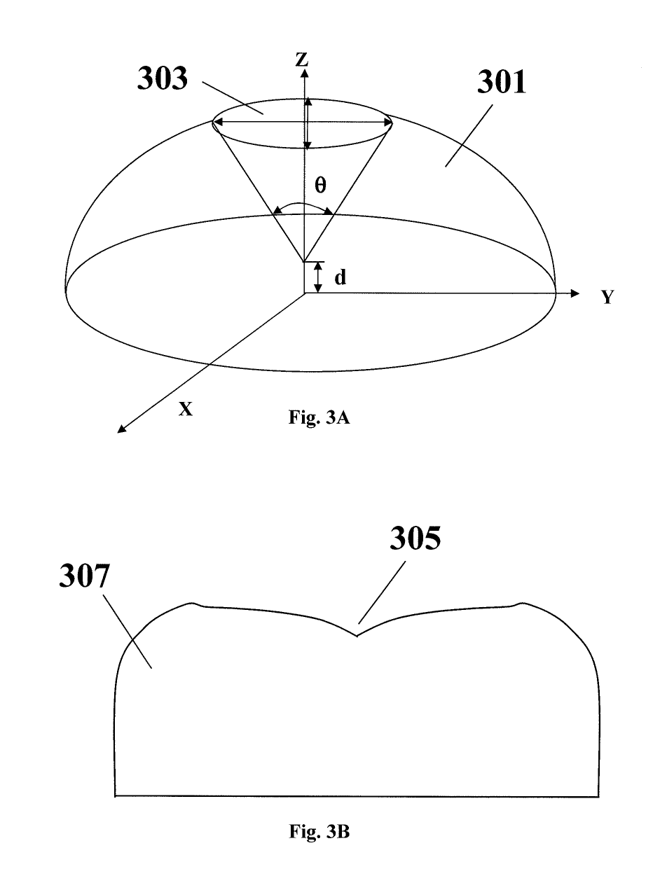

In certain embodiments, the batwing cavity 303 is a right cone. The base of the cone may be circular of elliptical. In some instances the base of the cone would correspond to the base plane of the lens. Thus, the cone may be a right circular cone or a right elliptical cone. FIGS. 3A and 4A show some dimensions associated with a right cone. The cone base is defined by perpendicular diameters “a” along a major axis and “b” along a minor axis. When the cone base is a circle, the diameters are the same. The cone is also defined by an aperture angle θ. The aperture angle affects the angle of incidence on the surface of the cone and hence the shape of the batwing pattern. Generally, increasing the aperture angle also increases the viewing angle of the batwing pattern. The distance between the cone tip and the lens base plane, shown as distance “d” in FIG. 3A, further defines the batwing pattern shape. Generally, the relationship between the aperture and the distance “d” affect the modulation depth of the pattern. FIGS. 2A and 2B are plots of intensity at different angles at different lines across the lens. The middle of the batwing pattern is a valley, with two peaks on either side of the valley. The modulation depth is a percentage ratio of the height of the valley and the peak. A smaller “d” generally results in higher modulation depth, and hence lower uniformity. The batwing pattern as shown in FIG. 2A has about 70% modulation depth.

In other embodiments, the batwing cavity is a cone having curved sides as shown in FIGS. 3B and 4B, which is referred to herein as parabolic. The cone may have a rounded point as shown or a sharp point such as the bottom of a spinning top. The parabolic cone is a right cone such that all horizontal slices parallel to the base plane include ellipses having the same aspect ratio. The curvature of the sides would affect the position and shape of the peaks. For example, the peaks may be shifted outwards so as to increase the viewing angle or shifted inwards to decrease the viewing angle by using different curves for the sides (either convex or concave relative to the sides of cone of FIG. 4A).

FIG. 3C shows yet another lens embodiment where the lens base is a polygon-based shape. As shown, the lens base is a rectangle with rounded corners. The batwing cavity corresponding to the lens of FIG. 3C is similar to the cavity illustrated in FIG. 4C. FIG. 4C shows an embodiment where a pyramid cavity is used. The pyramid has a base having sides “a” and “b”, with a table depth of “c”. Similar to the elliptical cone, the pyramid base dimensions may be proportional to the LED die. The pyramid is a right pyramid such that all horizontal slices parallel to the base plane include rectangles having the same aspect ratio. When the sides “a” and “b” are equal, the pyramid base is a square.

The pyramid cavity also has a base and sides. The base of the pyramid's cavity may be formed at an angle that is the same or offset angularly from the LED die. In other words, the horizontal angular orientation of the pyramid cavity base and the LED die may be different—the corners of the pyramid cavity base may point at 0, 90, 180, and 270 degrees, and the corners of the LED die may point at 45, 135, 225, and 315 degrees. As explained in association with FIG. 2, the batwing pattern peaks are higher on the diagonal lines for a rectangular die. When a pyramid cavity is used, the higher peaks may be magnified or reduced depending on the horizontal orientation of the pyramid cavity. Although FIG. 4C shows a pyramid base having four sides, fewer or more sides may be used. For example, a hexagonal or an octagonal base may be used.

In FIG. 4D, the batwing cavity is a pyramid having curved sides, which is referred to herein as a parabolic pyramid. The parabolic pyramid may have a rounded point as shown or a sharp point. Similar to the parabolic cone, the curvature of the sides would affect the position and shape of the peaks. For example, the peaks may be shifted outwards so as to increase the viewing angle or shifted inwards to decrease the viewing angle by using different curves for the sides (either convex or concave relative to the sides of pyramid of FIG. 4C). In addition to the embodiments shown in FIGS. 4A to 4D, the scope of the present disclosure encompasses other batwing cavities that can be configured in a lens to generate a batwing beam pattern. For example, a batwing cavity may have a clover-shaped base.

The batwing cavity is designed such that light reaching the batwing surface from the LED die is mostly reflected off the surface of the cavity. The batwing cavity may be designed such that the most of the light reaching the surface is reflected as total internal reflection (TIR). TIR is an optical phenomenon that occurs when a ray of light strikes a boundary between two medium at an angle larger than a particular critical angle with respect to the normal to the surface. At this larger angle, if the refractive index is lower on the other side of the boundary, no light can pass through and all of the light is reflected. The critical angle is the angle of incidence above which the total internal reflection occurs. If the angle of incidence is greater (i.e. the ray is closer to being parallel to the boundary) than the critical angle—the angle of incidence at which light is refracted such that it travels along the boundary—then the light will stop crossing the boundary altogether and instead be totally reflected back internally. The batwing cavity surface in the lens of the optical emitter in accordance with various embodiments of the present invention has a surface that renders most of the angle of incidence greater than the critical angle. Because the refractive index in the cavity is lower (for example, air has a refractive index of about 1) than that of the lens (for example, silicon molding has refractive indices of about 1.4 to 1.55), most of the light from the LED is reflected as TIR.

The batwing cavity may also be designed such that most of the light reaching the surface is reflected by a surface coating. A high reflectivity surface coating such as silver or other metals, some metal oxides such as titanium oxide and zirconium oxide, or another known highly reflective coating may be used. Examples of other known highly reflective coatings include dielectric films tuned to reflect the specific wavelengths of light emitted by the LED die. In some embodiments, the surface coating selected reflects more than 80% of the incident light, about 90% of the incident light, or more than 90% of the incident light.

The batwing cavity design may include elements of design for TIR with a reflective surface coating. The reflective surface coating may be designed to reduce reflection for light incident at less than the critical angle. Depending on the beam pattern uniformity requirement or specified modulation depth, more or less of the light may be designed pass through the batwing cavity surface by changing the surface coating materials. Given the concepts discussed herein, the batwing cavity and optional surface coating can be chosen to achieve any batwing beam pattern for a particular application.

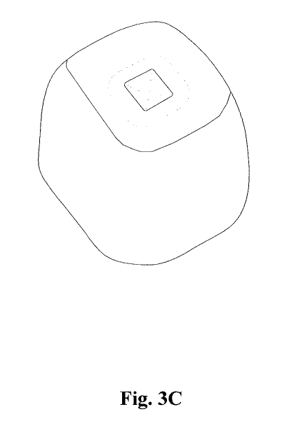

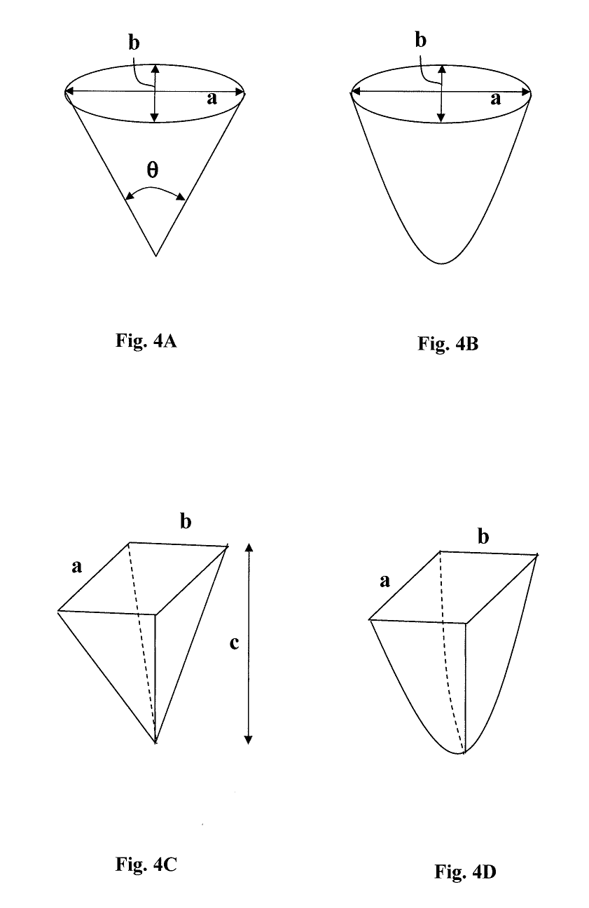

Illustrated in FIG. 5 is a flowchart of a method 501 for fabricating an optical emitter in accordance with the present disclosure. FIGS. 6 to 10 are diagrammatic fragmentary cross-sectional side views of the optical emitter during various fabrication stages in accordance with one embodiment of the method 501 in FIG. 5. The optical emitter may be a standalone device or a part of an integrated circuit (IC) chip or system on chip (SoC) that may include various passive and active microelectronic devices such as resistors, capacitors, inductors, diodes, metal-oxide semiconductor field effect transistors (MOSFET), complementary metal-oxide semiconductor (CMOS) transistors, bipolar junction transistors (BJT), laterally diffused MOS (LDMOS) transistors, high power MOS transistors, or other types of transistors. It is understood that FIGS. 6 to 10 have been simplified for a better understanding of the inventive concepts of the present disclosure. Accordingly, it should be noted that additional processes may be provided before, during, and after the method 501 of FIG. 5, and that some other processes may only be briefly described herein.

Referring to FIG. 5, the method 501 begins with block 503 in which a Light-Emitting Diode (LED) die is attached to a package substrate. FIG. 6 shows a cross-sectional view of the LED die 103 attached to package substrate 101. An LED die 103 includes a light-emitting structure (not shown) and one or more electrode pads for electrically connecting to a package substrate, the details of which are not shown in FIG. 6. While the following disclosure refers to an optical emitter with a blue LED, the concepts describes herein could apply to other color LEDs and even those without phosphors. The light-emitting structure has two doped layers and a multiple quantum well layer between the doped layers. The doped layers are oppositely doped semiconductor layers. In some embodiments, a first doped layer includes an n-type gallium nitride material, and the second doped layer includes a p-type material. In other embodiments, the first doped layer includes a p-type gallium nitride material, and the second doped layer includes an n-type gallium nitride material. The MQW layer includes alternating (or periodic) layers of active material, for example, gallium nitride and indium gallium nitride. For example, in one embodiment, the MQW layer includes ten layers of gallium nitride and ten layers of indium gallium nitride, where an indium gallium nitride layer is formed on a gallium nitride layer, and another gallium nitride layer is formed on the indium gallium nitride layer, and so on and so forth.

The doped layers and the MQW layer are all formed by epitaxial growth processes. After the completion of the epitaxial growth process, a p-n junction (or a p-n diode) is essentially formed. When an electrical voltage is applied between the doped layers, an electrical current flows through the light-emitting structure, and the MQW layer emits light. The color of the light emitted by the MQW layer is associated with the wavelength of the emitted radiation, which may be tuned by varying the composition and structure of the materials that make up the MQW layer. The light-emitting structure may optionally include additional layers such as a buffer layer between the substrate and the first doped layer, a reflective layer, and an ohmic contact layer. A suitable buffer layer may be made of an undoped material of the first doped layer or other similar material. A light-reflecting layer may be a metal, such as aluminum, copper, titanium, silver, alloys of these, or combinations thereof. An ohmic contact layer may be an indium tin oxide (ITO) layer. The light reflecting layer and ohmic contact layer may be formed by a physical vapor deposition (PVD) process or a chemical vapor deposition (CVD) or other deposition processes.

The LED die may be attached to the package substrate in a number of ways. In certain embodiments where the growth substrate side of the LED die is attached to the package substrate, the attachment may be performed by simply gluing the LED die using any suitable conductive or non-conductive glue. In embodiments where the LED die side opposite of the growth substrate is attached to the package substrate, the attachment may include electrically connecting the LED die by bonding the electrode pads on the LED to contact pads on the package substrate. This bonding may involve soldering or other metal bonding. In some embodiments, the growth substrate is removed and one side of the LED die is bonded and electrically connected to the substrate. In this case the attaching may be accomplished using metal bonding such as eutectic bonding.

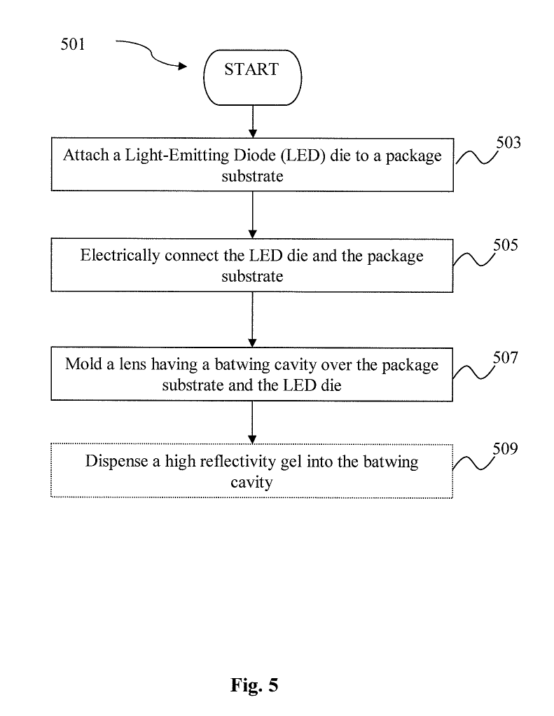

After the LED die is attached to the substrate, the LED die is electrically connected to the package substrate in operation 505 of FIG. 5. At least two electrical connections are made, one each to the p-type and n-type doped layers. In some cases, two electrical connections are made to the p-type layer for current spreading purposes. As discussed, the electrical connection may involve wire bonding, soldering, metal bonding, or a combination of these. FIG. 7 shows electrical connections 107 from the LED die 103 to terminals (not shown) on a package substrate 101. Because the electrical connection 107 may take a variety of forms, the structure shown in FIG. 7 is illustrative only—the electrical connections 107 need not be a wire bond.

After the LED die is connected to the package substrate, the process can take a variety of paths to form the optical emitter. For example, a reflector may be formed at this time around the LED die, either by attaching/gluing a pre-made reflector or molding a reflector in place. The reflector can further shape the batwing pattern by limiting light output at the extreme angles. In addition or instead of forming the reflector, a phosphor coating may be added to the package. Usually, but not always, phosphor material in a viscous fluid medium is sprayed onto the LED die in a relatively uniform coating. The phosphor material may be cured to set. However, if a reflector is formed around the LED die, an easier process of dispensing the phosphor coating may be used. Because the reflector surrounds the die and forms a volume in the middle of the package, the phosphor material in a viscous fluid medium can be simply dropped or dispensed into the center of the package to cover the LED die. This process increases the process window, or tolerance for non-uniform processing conditions, because the uniformity and dose issues associated with spray coating are avoided.

Referring back to FIG. 5, at operation 507 a lens having a batwing cavity is molded over the package substrate and the LED die. The lens may be formed by injection molding or compression molding. A variety of materials may be used as the lens. Suitable materials have a high optical permissivity (transparency), a viscosity suitable for molding, appropriate adhesion to the package substrate, and good thermal conductivity and stability (i.e., do not degrade or change color during thermal cycling). Example materials include silicone, epoxy, certain polymers, resins and plastics including Poly(methyl methacrylate) (PMMA). Suitable materials are flowable for molding into the lens and can be cured into a defined shape. Some suitable materials may have thermal expansion coefficients that are similar to that of the package substrate and/or can absorb stress caused by a difference in the thermal expansion during thermal cycling. Examples of suitable lens material include Shin-Etsu's line of SCR and KER silicone resin and rubber materials and Dow Cornings' various lines of silicon gel, elastomer, and silicone resin. As understood, a manufacturer in the industry can adjust the refractive index of the lens material as customer specifies. Thus, one skilled in the art can select a suitable lens material based on suitable material properties other than the refractive index first, then specify the refractive index within a range that can be supplied by the manufacturer.

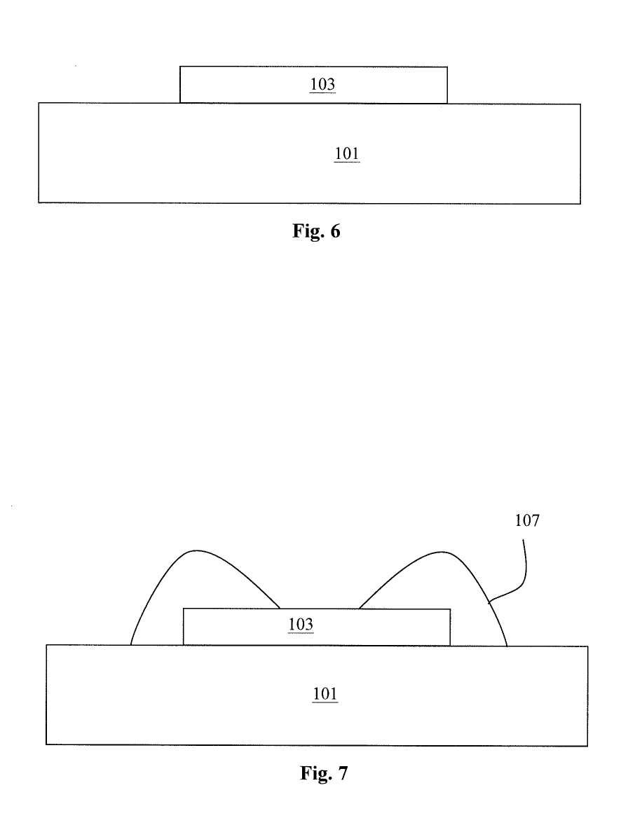

In certain embodiments, an injection molding method is used as shown in FIGS. 8 to 11. Referring to FIG. 8, a lens mold 817 is placed over LED die 103. The lens mold 817 includes multiple openings such as openings 819 and 821. The position and number of opening on the lens mold 817 as depicted is illustrative and not limiting. More openings may be used and the openings may be located at different places. FIG. 8 illustrates one mold cavity 823 placed over one LED die 103, however, the lens mold may include multiple mold cavities that would fit over a package substrate having many LED dies 103 attached thereon. The package substrate 101 may include alignment marks between individual LED dies to ensure that the mold cavities 823 are placed accurately over the LED die 103.

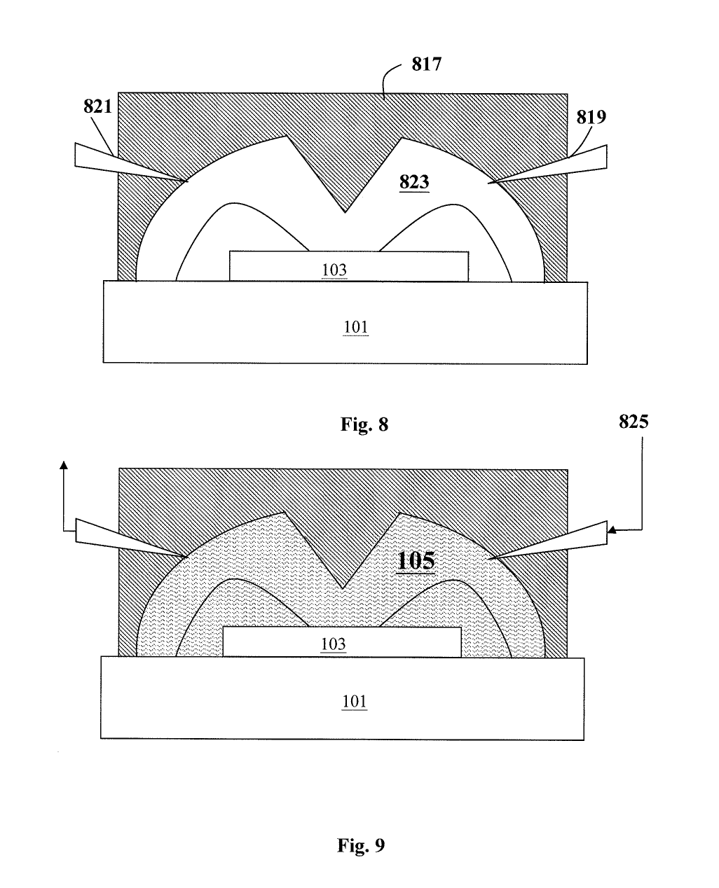

A lens glue or molding material is inserted into the lens mold as illustrated in FIG. 9. The lens glue 825 is inserted or injected into the mold cavity 823. To ensure a good fill, the gas inside the mold cavity 823 may be evacuated through one or more openings 821. The gas inside the mold cavity 823 may be air or an inert gas such as nitrogen. Alternatively, this operation is performed in a vacuum environment, in which instance opening 821 is not used. The lens glue 825 may be heated or under pressure. The lens glue 825 fills the mold cavity 823 to form the lens 105.

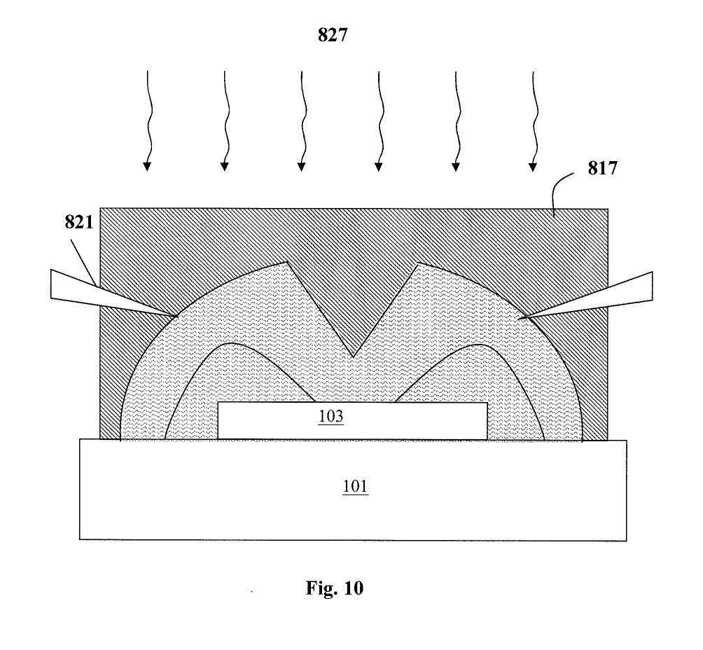

The lens 105 is cured to set so that it retains its shape and adheres to the package substrate and LED die as shown in FIG. 10. Radiation 827 or other energy is applied to the lens mold that is transparent to the radiation 827. The radiation may be an ultraviolet (UV) radiation, thermal radiation (infrared), microwave, or another radiation that can cure the lens glue. Glue materials that cure under UV light or under heat application are commercially available. In some instances, curing may be accomplished by only thermal energy, which need not be applied in the form of radiation. Conductive heat energy may be applied through the package substrate 101 or through heating of the lens mold 817.

After the lens has cured, the lens mold may be removed. The lens mold 817 is removed so as not to remove the lens 105 from the package substrate 101. In one embodiment, some gas can be added via one or all of the mold openings such as opening 821 to help separate the lens 105 from the lens mold 817. Other techniques include changing the temperature of either the molded lens or the lens mold such that a temperature difference exists. Further techniques include using a removal template in the lens mold 817 before injection of the lens glue. After the lens mold 817 is removed, the optical emitter including a batwing lens is formed as shown in FIG. 1.

In some embodiments, a compression molding method is used to form the batwing lens. Lens precursor material is applied onto the LED die and a lens mold is fitted over the LED die. Pressure is added to shape the lens precursor material according to the mold cavity. The lens precursor material is then cured to set the lens shape. The lens mold for the compression-molded lens is removed in a similar fashion as the injection-molded lens.

After the lens having a batwing cavity is formed on the LED package, the internal surface of the batwing cavity may be optionally coated with a reflective material. As noted above, the required reflectivity of the surface coating material depends on the batwing beam pattern requirements and a variety of coating material may be used. The surface coating material may be dispensed, sprayed, spun, or otherwise deposited on the cavity internal surface. An example would be to use as a gel, for example, a silicon gel, dispensed into the batwing cavity. In some instances the surface coating merely coats the cavity internal surface. In other instances the surface coating may fill the entire cavity.

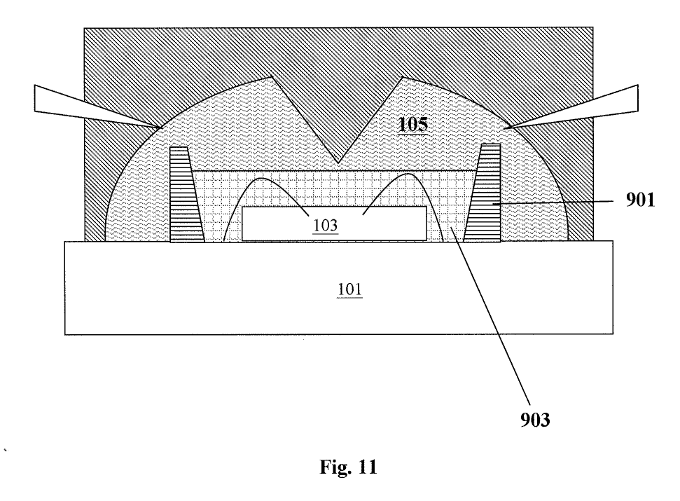

FIG. 11 shows the embodiment where the reflector 901 and phosphor coating 903 are formed first on the package substrate 101 before lens 105 formation. While the Figure shows the lens surrounding the reflector, in some embodiments the lens may be formed on the reflector and over the LED die, but not necessarily outside of the reflector.

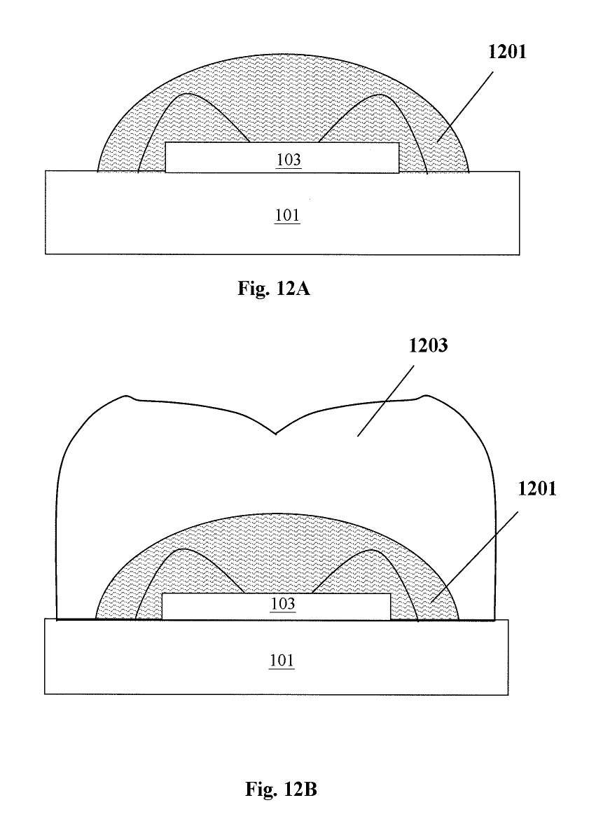

FIGS. 12A and 12B illustrate other embodiments where a phosphor component 1201 is formed before the molded lens 1203. As shown in FIG. 12A, the phosphor component 1201 may have an ellipsoidal shape such as a portion of an ellipsoid. The phosphor component 1201 may be formed by molding using a process similar to that described above to form the batwing lens or by dispensing phosphor material suspended in a highly viscous fluid medium, in some cases with surface tension that would retain a curved surface as shown. The phosphor component precursor may be the same material as the molded lens precursor.

After the phosphor component is 1201 formed, then the batwing lens 1203 is formed over the partially fabricated optical emitter using processes described above in association in operation 507 of FIG. 5 and FIGS. 8-10. One feature of the embodiments in FIGS. 12A and 12B is that the phosphor component encapsulates and protects the electrical connections which may be flexible wire bonding.

The optical emitter according to various embodiments of the present disclosure is not limited to emitters having only one LED die. Rather, a number of LED dies may be used in one optical emitter with one batwing lens over all of the LED dies. The LED dies may be arranged in linear array, in a rectangular array, or in a circle or other shapes. In one embodiment, three LED dies are arranged to form vertices of an equilateral triangle. In another embodiment, five LED dies are arranged to form two rows—one row of two LED dies and one row of three LED dies. In each of these multiple LED die configurations, one batwing lens is formed over the LED dies. In some embodiments, smaller lenses are formed over each of the LED dies first before the larger batwing lens is formed over the LED dies.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. It is understood, however, that these advantages are not meant to be limiting, and that other embodiments may offer other advantages. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. An optical emitter comprising:
a Light-Emitting Diode (LED) die;
a package substrate attached to one side of the LED die;
electrical connections connecting the LED die and terminals on the package substrate; and
a molded lens bonded to the package substrate directly contacting the LED die, said molded lens having an ellipsoidal cross section with a batwing cavity centered over the LED die.

2. The optical emitter of claim 1, wherein the molded lens includes a high reflectivity coating on the cavity surface.

3. The optical emitter of claim 2, wherein the high reflectivity coating reflects at least 90% of incident light.

4. The optical emitter of claim 2, wherein the high reflectivity coating includes a metal.

5. The optical emitter of claim 1, wherein the cavity is a cone.

6. The optical emitter of claim 5, wherein the cavity has an aperture that causes the cavity surface to totally internally reflect light generated from a center of the LED.

7. The optical emitter of claim 1, wherein the cavity is an elliptical cone.

8. The optical emitter of claim 1, wherein the cavity is a pyramid.

9. The optical emitter of claim 1, wherein the molded lens is a silicone, a resin, an epoxy, or a poly(methyl methacrylate) (PMMA).

10. The optical emitter of claim 1, wherein the optical emitter is about or smaller than 3.5 mm by 3.5 mm.

11. The optical emitter of claim 1, wherein the molded lens base is a polygon with rounded corners.

12. A method of fabricating an optical emitter, comprising:
attaching a Light-Emitting Diode (LED) die to a package substrate;
electrically connecting the LED die and the package substrate; and,
molding a lens over the package substrate and the LED die, wherein the molded lens includes a batwing cavity over the LED die.

13. The method of claim 12, wherein the molding a lens over the package substrate and the LED die comprises:
placing a lens mold over the package substrate and the LED die;
inserting a lens glue into the lens mold; and
curing a molded lens.

14. The method of claim 13, wherein the inserting a lens glue includes evacuating a space inside the lens mold.

15. The method of claim 13, wherein the curing a molded lens comprises exposing the lens glue to ultraviolet light through the lens mold or heating the lens glue.

16. The method of claim 12, further comprising dispensing a high reflectivity gel into the batwing cavity that completely coats the conical cavity surface.

17. The method of claim 16, wherein the high reflectivity gel comprises a metal.

18. The method of claim 16, wherein the metal is silver.

19. The method of claim 12, wherein the molded lens is a half ellipsoid with a conical portion removed from middle of the curved surface away from the LED die.

20. The method of claim 12, further comprising
molding a reflector on the package substrate around the LED die; and
dispensing a phosphor material in a volume formed by the molded reflector,
wherein molding a lens occurs after dispensing the phosphor material.

21. The method of claim 12, further comprising:
forming a phosphor component over the LED die before the molding a lens.

22. A display comprising:
a plurality of optical emitters, each optical emitter comprising:
a Light-Emitting Diode (LED) die;
a package substrate attached to one side of the LED die;
electrical connections connecting the LED die and the package substrate; and
a molded lens bonded to the package substrate directly contacting the LED die, said molded lens having an ellipsoidal cross section with a batwing cavity centered over the LED die.

23. An optical emitter comprising:
a plurality of Light-Emitting Diode (LED) dies;
a package substrate attached to one side of the plurality of LED dies;
electrical connections connecting the plurality of LED dies and terminals on the package substrate; and
a molded lens bonded to the package substrate directly contacting the plurality of LED dies, said molded lens having an ellipsoidal cross section with a batwing cavity.
